(19) United States
(12) Patent Application Publication
(10) Pub. No.: US 2021/0389937 A1
(43) Pub. Date: Dec. 16, 2021

(54) Systems And Methods For Fixing Incompatibilities In Field Firmware Updates

(71) Applicant: Western Digital Technologies, Inc., San Jose, CA (US)

(72) Inventors: Kalpit Bordia, Bengaluru (IN); Karthik Subramanian, Bengaluru (IN)

(21) Appl. No.: 16/900,617

(22) Filed: Jun. 12, 2020

(51) Int. Cl. G06F 8/65; G06F 8/61; G06F 11/14; G06F 3/06

(52) U.S. Cl. CPC G06F 8/65; G06F 8/63; G06F 11/1417; G06F 3/067; G06F 3/0614; G06F 3/0629; G06F 3/0607

(57) ABSTRACT

A storage device includes a controller that is configured to direct the storage device to download an updated firmware image to the storage device. The storage device includes with a pre-existing firmware while the updated firmware image comprises incompatibility correcting functions. The storage device then performs a compatibility check on the updated firmware image, and determines the presence of one or more incompatibilities between the updated firmware image and the pre-existing firmware. In the event of a determined incompatibility between the updated firmware image and the pre-existing firmware, the controller can direct the storage device to begin a transient execution phase wherein at least one of the incompatibility correcting functions is processed upon receipt of a request to updated the downloaded firmware image. The storage device can reset upon completion of the transient code execution phase, loads the updated firmware image, and proceeds to function according to the new firmware.

This disclosure relates to field firmware updates. More particularly, the present disclosure technically relates to fixing incompatibilities in field firmware updates of storage devices.

### BACKGROUND

Field Firmware Updates (“FFUs”) are increasingly utilized in microcontroller-based devices and applications including, but not limited to, storage devices comprising non-volatile memory arrays. An FFU process may be configured to fix bugs, improve performance, and/or enhance features. In many applications, the FFU process can be supported as part of the device protocol standard. FFU processes are typically configured to be nondestructive, meaning that any data within a storage device, for example, will remain unchanged after the FFU has completed. An FFU can be carried out in many instances by downloading and/or otherwise providing an updated firmware image file to the host device.

However, there are cases where the original firmware and the updated firmware image are not compatible. In such instances, incompatibility of the new firmware image prevents the updated firmware from installing, leaving any bugs or performance issues to remain that were meant to be addressed by the updated firmware. Often due to lack of compatible updates, vendors need to provide new storage devices which have to undergo complete recertification from the original equipment manufacturer (“OEM”). This recertification process can be very costly and may undesirably increase the amount of downtime for the particular device and/or host system. Similarly, if the devices were already deployed with consumer and bug fixes cannot be done via FFU it may require the complete storage device to be replaced which is also very costly.

### BRIEF DESCRIPTION OF DRAWINGS

The foregoing summary is illustrative and is not intended to be in any way limiting. In addition to the illustrative aspects, embodiments, and features described above, further aspects, embodiments, and features will become apparent by reference to the following drawings and the detailed description.

FIG. 1 is a schematic block diagram of a host-computing device with a storage device suitable for field firmware updates in accordance with an embodiment of the invention;

FIG. 2 is a schematic block diagram of a storage device suitable for field firmware updates in accordance with an embodiment of the invention;

FIG. 3 is a high-level flowchart depicting a field firmware update process configured to correct incompatibilities in accordance with an embodiment of the invention;

FIG. 4 is a middle-level flowchart depicting a process for fixing incompatibilities during a field firmware update in accordance with embodiments of the invention;

FIG. 5 is a detailed flowchart depicting a process for fixing incompatibilities during a field firmware update in accordance with an embodiment of the invention; and

FIG. 6 is a detailed flowchart depicting a process for fixing incompatibilities during a field firmware update prior to firmware activation in accordance with an embodiment of the invention.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, systems and methods are discussed herein that describe processes for fixing incompatibilities within field firmware updates. As described in more detail below, many embodiments of the present application include the inclusion of a transient phase that can utilize specialized code and/or functions to generate a plurality of fixes to incompatibilities between original firmware and an updated firmware. This transient phase can, in some embodiments, augment or supplant the original firmware update process. In a number of embodiments, the updated firmware and transient code and/or functions are ultimately stored within the non-volatile memory of the storage device to facilitate potential rollbacks or future updates. In most embodiments, the process of identifying, processing, and correcting incompatibilities between firmware versions is accomplished such that the host device is not “aware” of or affected by this process. Indeed, the firmware processes described herein can be configured to be compliant with the protocol of the host device and/or storage device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

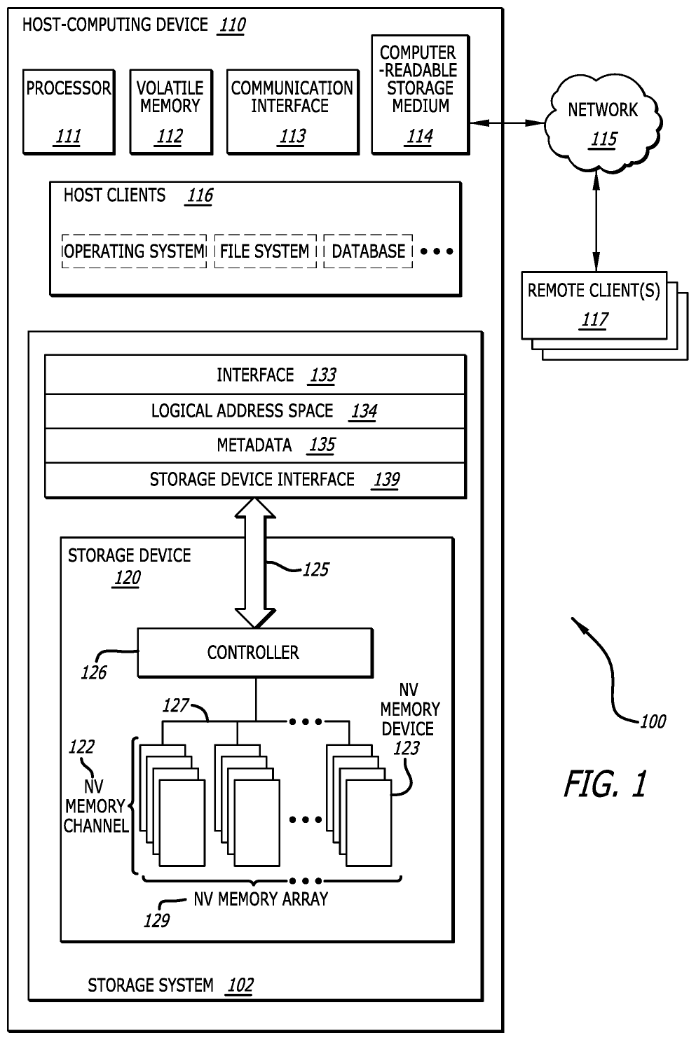

Referring to FIG. 1, a schematic block diagram of a host-computing device 110 with a storage system 102 suitable for field firmware updates in accordance with an embodiment of the invention is shown. The FFU update system 100 comprises one or more storage devices 120 of a storage system 102 within a host-computing device 110 in communication via a controller 126. The host-computing device 110 may include a processor 111, volatile memory 112, and a communication interface 113. The processor 111 may include one or more central processing units, one or more general-purpose processors, one or more application-specific processors, one or more virtual processors (e.g., the host-computing device 110 may be a virtual machine operating within a host), one or more processor cores, or the like. The communication interface 113 may include one or more network interfaces configured to communicatively couple the host-computing device 110 and/or controller 126 of the storage device 120 to a communication network 115, such as an Internet Protocol (IP) network, a Storage Area Network (SAN), wireless network, wired network, or the like.

The storage device 120, in various embodiments, may be disposed in one or more different locations relative to the host-computing device 110. In one embodiment, the storage device 120 comprises one or more non-volatile memory devices 123, such as semiconductor chips or packages or other integrated circuit devices disposed on one or more printed circuit boards, storage housings, and/or other mechanical and/or electrical support structures. For example, the storage device 120 may comprise one or more direct inline memory module (DIMM) cards, one or more expansion cards and/or daughter cards, a solid-state-drive (SSD) or other hard drive device, and/or may have another memory and/or storage form factor. The storage device 120 may be integrated with and/or mounted on a motherboard of the host-computing device 110, installed in a port and/or slot of the host-computing device 110, installed on a different host-computing device 110 and/or a dedicated storage appliance on the network 115, in communication with the host-computing device 110 over an external bus (e.g., an external hard drive), or the like.

The storage device 120, in one embodiment, may be disposed on a memory bus of a processor 111 (e.g., on the same memory bus as the volatile memory 112, on a different memory bus from the volatile memory 112, in place of the volatile memory 112, or the like). In a further embodiment, the storage device 120 may be disposed on a peripheral bus of the host-computing device 110, such as a peripheral component interconnect express (PCI Express or PCIe) bus such, as but not limited to a NVM Express (NVMe) interface, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the storage device 120 may be disposed on a data network 115, such as an Ethernet network, an Infiniband network, SCSI RDMA over a network 115, a storage area network (SAN), a local area network (LAN), a wide area network (WAN) such as the Internet, another wired and/or wireless network 115, or the like.

The host-computing device 110 may further comprise computer-readable storage medium 114. The computer-readable storage medium 114 may comprise executable instructions configured to cause the host-computing device 110 (e.g., processor 111) to perform steps of one or more of the methods disclosed herein. Additionally, or in the alternative, the buffering component 150 may be embodied as one or more computer-readable instructions stored on the computer-readable storage medium 114.

A device driver and/or the controller 126, in certain embodiments, may present a logical address space 134 to the host clients 116. As used herein, a logical address space 134 refers to a logical representation of memory resources. The logical address space 134 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the storage device 120 may maintain metadata 135, such as a logical to physical address mapping structure, to map logical addresses of the logical address space 134 to media storage locations on the storage device(s) 120. A device driver may be configured to provide storage services to one or more host clients 116. The host clients 116 may include local clients operating on the host-computing device 110 and/or remote host clients 117 accessible via the network 115 and/or communication interface 113. The host clients 116 may include, but are not limited to: operating systems, file systems, database applications, server applications, kernel-level processes, user-level processes, applications, and the like.

The device driver may be further communicatively coupled to one or more storage systems 102 which may include different types and configurations of storage devices 120 including, but not limited to: solid-state storage devices, semiconductor storage devices, SAN storage resources, or the like. The one or more storage devices 120 may comprise one or more respective controllers 126 and non-volatile memory channels 122. The device driver may provide access to the one or more storage devices 120 via any compatible protocols or interface 133 such as, but not limited to, SATA and PCIe. The metadata 135 may be used to manage and/or track data operations performed through the protocols or interfaces 133. The logical address space 134 may comprise a plurality of logical addresses, each corresponding to respective media locations of the one or more storage devices 120. The device driver may maintain metadata 135 comprising any-to-any mappings between logical addresses and media locations.

A device driver may further comprise and/or be in communication with a storage device interface 139 configured to transfer data, commands, and/or queries to the one or more storage devices 120 over a bus 125, which may include, but is not limited to: a memory bus of a processor 111, a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 115, Infiniband, SCSI RDMA, or the like. The storage device interface 139 may communicate with the one or more storage devices 120 using input-output control (IO-CTL) command(s), IO-CTL command extension(s), remote direct memory access, or the like.

The communication interface 113 may comprise one or more network interfaces configured to communicatively couple the host-computing device 110 and/or the controller 126 to a network 115 and/or to one or more remote host clients 117. The controller 126 is part of and/or in communication with one or more storage devices 120. Although FIG. 1 depicts a single storage device 120, the disclosure is not limited in this regard and could be adapted to incorporate any number of storage devices 120.

The storage device 120 may comprise one or more non-volatile memory devices 123 of non-volatile memory channels 122, which may include but is not limited to: ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more non-volatile memory devices 123 of the non-volatile memory channels 122, in certain embodiments, comprise storage class memory (SCM) (e.g., write in place memory, or the like).

While the non-volatile memory channels 122 is referred to herein as “memory media,” in various embodiments, the non-volatile memory channels 122 may more generally comprise one or more non-volatile recording media capable of recording data, which may be referred to as a non-volatile memory medium, a non-volatile storage medium, or the like. Further, the storage device 120, in various embodiments, may comprise a non-volatile recording device, a non-volatile memory array, a plurality of interconnected storage devices in an array, or the like.

The non-volatile memory channels 122 may comprise one or more non-volatile memory devices 123, which may include, but are not limited to: chips, packages, planes, die, or the like. A controller 126 may be configured to manage data operations on the non-volatile memory channels 122, and may comprise one or more processors, programmable processors (e.g., FPGAs), ASICs, micro-controllers, or the like. In some embodiments, the controller 126 is configured to store data on and/or read data from the non-volatile memory channels 122, to transfer data to/from the storage device 120, and so on.

The controller 126 may be communicatively coupled to the non-volatile memory channels 122 by way of a bus 127. The bus 127 may comprise an I/O bus for communicating data to/from the non-volatile memory devices 123. The bus 127 may further comprise a control bus for communicating addressing and other command and control information to the non-volatile memory devices 123. In some embodiments, the bus 127 may communicatively couple the non-volatile memory devices 123 to the controller 126 in parallel. This parallel access may allow the non-volatile memory devices 123 to be managed as a group, forming a non-volatile memory array 129. The non-volatile memory devices 123 may be partitioned into respective logical memory units (e.g., logical pages) and/or logical memory divisions (e.g., logical blocks). The logical memory units may be formed by logically combining physical memory units of each of the non-volatile memory devices 123.

The controller 126 may organize a block of word lines within a non-volatile memory device 123, in certain embodiments, using addresses of the word lines, such that the word lines are logically organized into a monotonically increasing sequence (e.g., decoding and/or translating addresses for word lines into a monotonically increasing sequence, or the like). In a further embodiment, word lines of a block within a non-volatile memory device 123 may be physically arranged in a monotonically increasing sequence of word line addresses, with consecutively addressed word lines also being physically adjacent (e.g., WL0, WL1, WL2, . . . WLN).

The controller 126 may comprise and/or be in communication with a device driver executing on the host-computing device 110. A device driver may provide storage services to the host clients 116 via one or more interfaces 133. A device driver may further comprise a storage device interface 139 that is configured to transfer data, commands, and/or queries to the controller 126 over a bus 125, as described above.

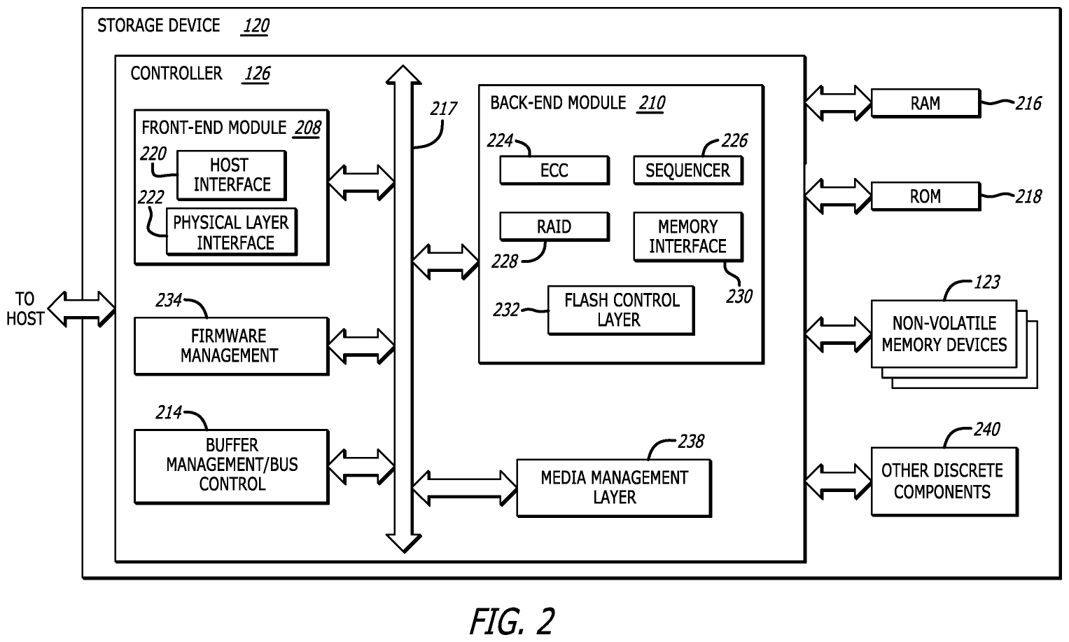

FIG. 2 is a block diagram illustrating exemplary components of the storage device 120 in more detail. The controller 126 may include a front-end module 208 that interfaces with a host, a back-end module 210 that interfaces with the non-volatile memory devices 123, and various other modules that perform various functions of the storage device 120. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module.

The controller 126 may include a buffer management/bus control module 214 that manages buffers in random access memory (RAM) 216 and controls the internal bus arbitration for communication on an internal communications bus 217 of the controller 126. A read only memory (ROM) 218 may store and/or access system boot code. Although illustrated in FIG. 2 as located separately from the controller 126, in other embodiments one or both of the RAM 216 and the ROM 218 may be located within the controller 126. In yet other embodiments, portions of RAM 216 and ROM 218 may be located both within the controller 126 and outside the controller 126. Further, in some implementations, the controller 126, the RAM 216, and the ROM 218 may be located on separate semiconductor dies. As discussed below, in one implementation, the submission queues and the completion queues may be stored in a controller memory buffer, which may be housed in RAM 216.

Additionally, the front-end module 208 may include a host interface 220 and a physical layer interface 222 that provides the electrical interface with the host or next level storage controller. The choice of the type of the host interface 220 can depend on the type of memory being used. Examples types of the host interfaces 220 may include, but are not limited to, SATA, SATA Express, SAS, Fibre Channel, USB, PCIe, and NVMe. The host interface 220 may typically facilitate transfer for data, control signals, and timing signals.

The back-end module 210 may include an error correction controller (ECC) engine 224 that encodes the data bytes received from the host and decodes and error corrects the data bytes read from the non-volatile memory devices 123. The back-end module 210 may also include a command sequencer 226 that generates command sequences, such as program, read, and erase command sequences, to be transmitted to the non-volatile memory devices 123. Additionally, the back-end module 210 may include a RAID (Redundant Array of Independent Drives) module 228 that manages generation of RAID parity and recovery of failed data. The RAID parity may be used as an additional level of integrity protection for the data being written into the storage device 120. In some cases, the RAID module 228 may be a part of the ECC engine 224. A memory interface 230 provides the command sequences to the non-volatile memory devices 123 and receives status information from the non-volatile memory devices 123. Along with the command sequences and status information, data to be programmed into and read from the non-volatile memory devices 123 may be communicated through the memory interface 230. A flash control layer 232 may control the overall operation of back-end module 210.

Additional modules of the storage device 120 illustrated in FIG. 2 may include a media management layer 238, which performs wear leveling of memory cells of the non-volatile memory devices 123. The storage device 120 may also include other discrete components 240, such as external electrical interfaces, external RAM, resistors, capacitors, or other components that may interface with controller 126. In alternative embodiments, one or more of the RAID modules 228, media management layer 238 and buffer management/bus controller 214 are optional components that may not be necessary in the controller 126.

Finally, the controller 126 may also comprise a firmware management module 234 that can be configured to check for, download, and otherwise receive new firmware(s) for the storage device 120. As described in more detail below, the firmware management module 234 can accept and store images that comprise updated firmware and a plurality of incompatibility correcting functions. These functions can be configured to augment and/or supplant the newly downloaded firmware. It is envisioned that these updates may be performed on or with respect to non-host data, prior to activation and loading of the updated firmware to ensure the storage device 120 can support the updated firmware.

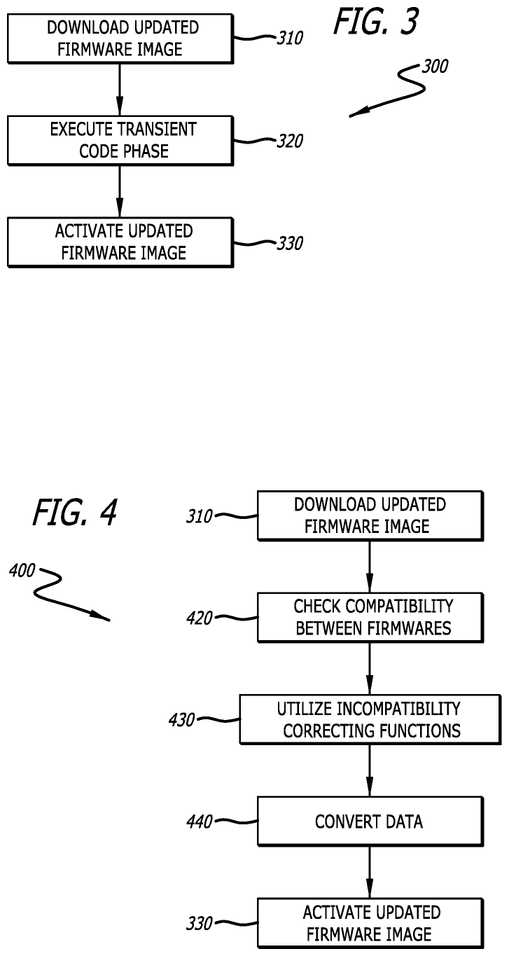

Referring to FIG. 3, a high-level flowchart depicting a field firmware update process 300 configured to correct incompatibilities in accordance with an embodiment of the invention is shown. In traditional FFU processes, updated firmware image is typically downloaded and activated as a two-step process, with no intermediate step. The process 300 depicted in FIG. 3 depicts the utilization of a transient code execution phase (block 320). More specifically, the storage device can download an updated firmware image (block 310). The updated firmware image may comprise a plurality of incompatibility correcting functions that may be utilized to fix a series of known potential incompatibilities between various firmware versions. On activation request for new firmware, the device can execute a transient code phase, during which the memory device can execute any of the incompatibility correcting functions that may be needed (block 320). The process 300 may, upon completion of the transient code phase, complete activation process of new firmware (block 330).

In this way, incompatibilities between various firmware may be addressed to allow the storage device to operate with the updated firmware configured to address various bugs, and/or provide enhanced performance and functionality. Although it is contemplated that embodiments described herein may be applied to any suitable storage device, many embodiments discussed herein relate to a solid-state drive (“SSD”) utilizing the NVMe specification and protocol.

Referring to FIG. 4, a middle-level flowchart depicting a process 400 for fixing incompatibilities during a field firmware update in accordance with embodiments of the invention is shown. The flowchart depicted in FIG. 4 can be considered a more detailed embodiment of the process 300 depicted in FIG. 3. Similar to that process 300, the process 400 can begin with the downloading of an updated firmware to the storage device (block 310).

In a number of embodiments, when download is completed and an activation command is received, the process 400 can evaluate the downloaded firmware for potential incompatibilities with the pre-existing firmware of the storage device (block 420). Compatibility checks may be configured to occur in a variety of ways. By way of example and not limitation, the developers of the updated firmware may contemplate that at least one or more incompatibilities may occur with pre-existing firmware in the field. Based on this knowledge, one or more incompatibility correcting functions may be included within the updated firmware in order to address these known incompatibilities. In this way, a compatibility check may utilize one or more rules and/or logics to evaluate the pre-existing firmware and deploy an incompatibility correcting function based on that determination (block 430). In additional embodiments, the compatibility check may evaluate the format of data stored within non-volatile memory prior to the firmware and the projected format of the data with the updated firmware (block 440). A difference between formats may indicate an incompatibility that can be addressed by utilizing an incompatibility correcting function that is configured to reformat the data from the original (first) format of the pre-existing firmware to an updated (second) format of the updated firmware. In many embodiments, the host data is not destroyed or otherwise affected by this type of formatting which is often limited to non-host data. The process 400 may continue the process of activating the firmware once the plurality of incompatibility correcting functions have converted data necessary to facilitate compatibility between the firmware (block 330). Once activated, the storage device can restart and execute the new firmware.

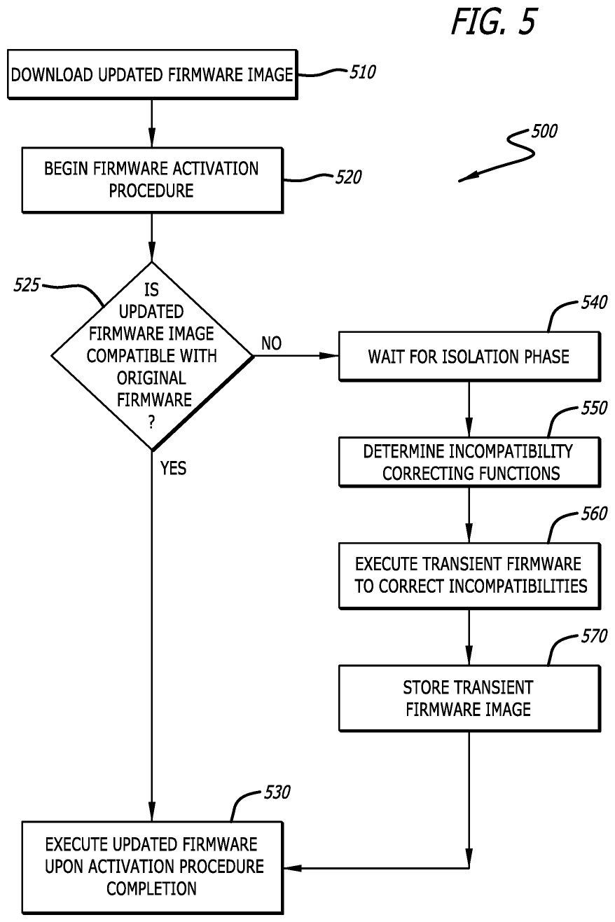

Referring to FIG. 5, a detailed flowchart depicting a process 500 for fixing incompatibilities during a field firmware update in accordance with an embodiment of the invention is shown. The process 500 can begin by downloading a new firmware image to the storage device (block 510). Although this embodiment depicts the new firmware being acquired through a download process, it is contemplated that in certain embodiments the new firmware image may be presented to the storage device through a method that does not require downloading, but merely access. Once downloaded, the host may send an activation command for the new firmware image to begin the update process (block 520). In many embodiments the host-computing device may utilize one or more protocols to send out a request for updated firmware image activation including, but not limited to, NVMe protocols. Request to begin activation may also be received from non-host sources including, but not limited to, an internal SSD controller, or remote device. It is also contemplated that certain embodiments may operate without the need for an activation request and may simply begin the activation process directly after download, after a pre-determined amount of time, or when the storage device is otherwise idle. In particular embodiments the download and activation steps may operate as a single command that encompasses both (or more) actions.

Upon beginning of the activation procedure, but prior to full activation and execution, the process 500 can determine if the new firmware image is compatible with the original firmware (block 525). Methods of determining compatibility are described in more detail in the discussion of FIG. 4. If it is determined that the new firmware is compatible with the pre-existing firmware, the process 500 can then complete activation by executing the new firmware image without further processing (block 530).

However, if incompatibilities between the new firmware image and pre-existing firmware image are detected, the process 500 can wait for an isolation phase or other period of inactivity in which the storage device does not service any host commands (block 540). In a variety of embodiments, the storage devices comprise at least two such isolation phases including the pre-reset phase and the post-reset phase for reset triggered activations. Typically, a pre-reset phase occurs when the storage device turns off various functionalities to prepare for the upcoming reset of the device. Conversely, a post-reset phase often comprises the period of time after a reset when the read-only memory (“ROM”) is booting up before the new firmware is loaded and executed. In numerous embodiments, the determination of the isolation phase is dependent upon the internal firmware of the storage device and is not detectable by the host computing system. In other words, communications between the host-computing device and the storage device is not interrupted during the firmware updating process.

Once a proper time has been determined to further execute the process 500, upon arrival of that time, the proper incompatibility correcting functions may be determined (block 550). As described within the discussion of FIG. 4, the determination of proper incompatibility functions may be the product of pre-defined rules and/or heuristics. In further embodiments, the formats of data can be compared pre- and post-firmware update. In some embodiments, this step may occur during the compatibility check of block 525. It is also contemplated that certain incompatibility correcting functions may alter data within the storage device that is not typically changed during a firmware update process including, but not limited to, meta data and configuration data in order to facilitate a longer effective life span and/or increased functionality. At the same time, some incompatibility correcting functions may not modify any data but only update a device driver and/or the controller 126 setting to facilitate new firmware. In a number of embodiments, the determined incompatibility correcting functions can be incorporated into a new transient firmware that has been generated specifically to provide compatibility between the specific pre-existing firmware on the storage device and the new updated firmware.

Once generated, the process 500 can execute the transient firmware to correct incompatibilities (block 560). This step can be configured to format all of the necessary data to provide proper functionality of the storage device to the host after loading the new firmware image. In fact, any number of processes that can be utilized to facilitate updating of a firmware image necessary to provide seamless operation of the storage device to the host computer can be utilized within the transient firmware. For example, storage devices often comprise meta data that is not provided by the host computer but is generated by the storage device. This meta data may include, but is not limited to, address mapping tables, host data parity for data corrections, etc. Because this data is often configured by the storage device manufacturer, it is contemplated that meta data may need to be reconfigured or reformatted to provide increased performance or to create more storage space for additional functions within the storage device that were not contemplated and/or installed during the initial manufacture and sale of the storage device. Additionally, configuration data within the storage device may be altered based on the desired application. By way of example and not limitation, configuration data may comprise thermal power handling operations. Based on new data acquired after manufacture and deployment, it may be desired to adjust this configuration data to change operating behaviors at different thermal loads. In this way, the effective lifespan of the storage device may be extended through updated configuration data that can be provided by executing the transient firmware.

In various embodiments, there may be a desire to rollback one or more firmware versions within a storage device. In order to facilitate such rollbacks, the transient firmware and associated incompatibility correcting functions must be addressable in order to undo the changes that were made. Therefore, many embodiments of the process 500 store the transient firmware image upon execution within an area of the non-volatile memory (block 570). In certain embodiments, the stored firmware(s) may require storage within the host data areas of the non-volatile memory. It is contemplated that over the course of a storage device's effective lifespan that multiple firmware versions will be installed and may need to be rolled back multiple versions to address a problem or regain particular functionality. In this way, each firmware, including the transient firmware and associated incompatibility correcting functions are stored for each version executed. In additional embodiments, the presence of data such as the incompatibility correcting functions may provide the storage device with data necessary to reverse the changes that occurred during the transient firmware execution. In further embodiments, downloaded and unused incompatibility correcting functions may be stored within the non-volatile memory upon completion of the update process to insure future compatibility. It is also contemplated that some embodiments of the stored transient firmware image may comprise specific functions related to rollback processes.

Once stored, the process 500 can then execute the new firmware image which will subsequently operate the storage device as intended by the developers (block 530). In this way, the desired outcome of the updated firmware, whether it be bug fixes, performance enhancements, or additional features, may be realized on an increased number of storage devices whether the storage device was initially compatible or not, or whether the storage device was deployed in the field.

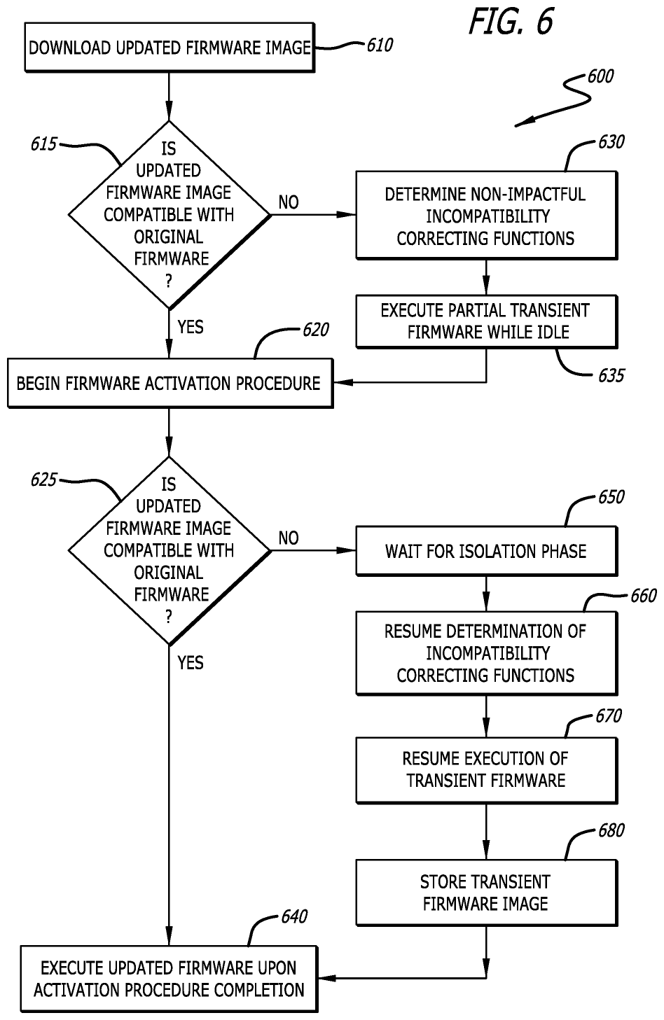

Referring to FIG. 6, a detailed flowchart depicting a process 600 for fixing incompatibilities during a field firmware update prior to firmware activation in accordance with an embodiment of the invention is shown. The process 600 provides an additional embodiment wherein at least some of the incompatibility processing and correction is done prior to the reception of activation command for the new firmware image. Similar to other embodiments discussed above, the process 600 can begin by downloading the new firmware image for processing (block 610). An initial determination can be made to evaluate if the newly downloaded firmware image is compatible with the pre-existing firmware (block 615). In many embodiments, if no compatibility issues are found, the process 600 can directly move to activation and execution of the new firmware image upon request (block 620).

In other embodiments, when an incompatibility is found, an initial determination can be made to evaluate if any incompatibilities can be processed prior to the activation command for the new firmware (block 630). It is contemplated that at least some of the potential incompatibilities may be corrected without affecting the present function of the storage device. For example, space may be available within the storage of the storage device to install a new feature or updated function that was not known or otherwise available to the pre-existing firmware. In this way, certain incompatibility correcting functions may be determined to execute as a partial transient firmware prior to activation of the new firmware (block 635). By way of example and not limitation, an updated firmware is downloaded that, once analyzed, is determined to add a new feature that requires the addition of new configuration data within the storage device. Because the pre-existing firmware is not configured to utilize this configuration data, the partial transient firmware may execute and add this new configuration data into the storage device's memory as a sort of “pre-load” before activation and loading of the new firmware image. In order to reduce and/or eliminate interruptions to the normal operation of the storage device, these pre-activation steps can often be configured to only operate during an idle period of activity for the storage device.

Upon reception of activation command completion of the pre-activation partial transient firmware execution stops, and activation process for the new firmware image is begins (block 620). During this process it can again be determined if the new firmware image is compatible with the original firmware (block 625). Methods of determining compatibility are again described in more detail in the discussion of FIG. 4. If it is determined that the new firmware is compatible with the pre-existing firmware, the process 600 can then load the new firmware image without further processing (block 640).

If incompatibilities between the new firmware image and pre-existing firmware image are still detected, the process 600 can wait for an isolation phase or other period of inactivity in which the storage device does not service any host commands (block 650). Once a proper time has been determined to further execute the process 600, upon arrival of that time, the determination of the proper incompatibility correcting functions may be resumed (block 660). In a number of embodiments, the determined remaining incompatibility correcting functions can also be incorporated into the transient firmware that was previously generated.

Once generation has completed, the process 600 can execute the transient firmware to correct the remaining incompatibilities (block 670). This step can be configured to format all of the necessary data to provide proper functionality of the storage device to the host after loading the new firmware image. Upon completion, many embodiments of the process 600 store the full transient firmware image within an area of the non-volatile memory (block 680). As described above with respect to the discussion of FIG. 5, it is again contemplated that over the course of a storage device's effective lifespan that multiple firmware versions will be installed and may need to be rolled back multiple versions to address a problem or regain particular functionality. In this way, each firmware, including the transient firmware and associated incompatibility correcting functions are store for each version executed. In additional embodiments, the presence of data such as the incompatibility correcting functions may provide the storage device with data necessary to reverse the changes that occurred during the transient firmware execution.

Once stored, the process 600 can then load the new firmware image which will subsequently operate the storage device as intended by the developers (block 640). Prior to execution, many embodiments may reset the storage device. In some embodiments, the resetting of the storage device may be required based upon the execution of one or more of the plurality of incompatibility correcting functions. In further embodiments, a reset of the storage device may be requested by the transient firmware which may be desired but can be delayed and/or denied based on the current demands of the host-computing system.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed is:

1. A storage device, comprising:
a controller configured to direct the storage device to:
download an updated firmware image to the storage device, wherein:
the storage device is configured with a pre-existing firmware; and
the updated firmware image comprises a plurality of incompatibility correcting functions;
perform a compatibility check between the updated firmware image and the pre-existing firmware; and
determine the presence of one or more incompatibilities between the updated firmware image and the pre-existing firmware;
begin activation of the updated firmware image upon request;
wherein, in the event of a determined incompatibility between the updated firmware image and the pre-existing firmware, the controller further directs the storage device to:
begin a transient code execution phase prior to activation of the firmware image, wherein at least one of the plurality of incompatibility correcting functions is processed; and
execute the updated firmware image upon completion of the activation.

2. The storage device of claim 1, wherein, in the event of a determined incompatibility between the updated firmware image and pre-existing firmware, the storage device further stores the updated firmware image within the non-volatile memory array of the storage device.

3. The storage device of claim 1, wherein the incompatibility correcting functions modify data within the storage device from an incompatible format to a compatible format.

4. The storage device of claim 3, wherein the data modified is meta data.

5. The storage device of claim 3, wherein the data modified is configuration data.

6. The storage device of claim 3, wherein no host data is modified during the firmware update process.

7. The storage device of claim 1, wherein the transient code execution phase occurs during a period of inactivity within the storage device.

8. The storage device of claim 7, wherein the period of inactivity is a pre-reset safe state.

9. The storage device of claim 7, wherein the period of inactivity is a post-reset loading state.

10. The storage device of claim 1, wherein the controller directs the storage device to reset itself during the transient code execution phase in response to a reset request.

11. A method for updating pre-existing firmware, comprising:
downloading an updated firmware image to a storage device with a pre-existing firmware;
wherein the downloaded firmware image comprises a plurality of incompatibility correcting functions;
performing a compatibility check on the updated firmware image;
determining the presence of one or more incompatibilities of the updated firmware image with the pre-existing firmware;
beginning activation of the downloaded firmware image upon request;
wherein, in the event of a determined incompatibility between the updated firmware image and the pre-existing firmware, the storage device:
begins a transient code execution phase wherein at least one of the plurality of incompatibility correcting functions is processed;
resets the storage device; and
executes the updated firmware image upon completion of the activation.

12. The method of claim 11, wherein in the event of a determined incompatibility between the updated firmware image and the pre-existing firmware, a reset is not required prior to loading the updated firmware image.

13. The method of claim 11, wherein in the event of a determined incompatibility between the updated firmware image and the pre-existing firmware, a reset is performed upon request.

14. The method of claim 11, wherein resets the storage device performs the reset upon completion of the transient code execution phase.

15. The method of claim 11, wherein the method does not alter normal communications with a host-computing device.

16. The method of claim 11, wherein the plurality of incompatibility correcting functions are stored within the storage device upon completion of the method.

17. The method of claim 16, wherein the plurality of incompatibility correcting functions are stored within the host memory of the storage device.

18. The method of claim 11, wherein at least one of the plurality of incompatibility correcting functions transforms data stored in storage from a first format to a second format.

19. The method of claim 11, wherein updating the firmware of the storage device does not destroy any host data.

20. A method for updating pre-existing firmware, comprising:
downloading an updated firmware image to a storage device with a pre-existing firmware wherein the updated firmware image comprises a plurality of incompatibility correcting functions;
performing a first compatibility check on the updated firmware image;
determining compatibility of the updated firmware image with the pre-existing firmware, wherein, in the event of a determined incompatibility between the updated firmware image and pre-existing firmware, the storage device begins a transient code execution phase wherein at least a first incompatibility correcting function of the plurality of incompatibility correcting functions is processed prior to receiving a request for activation of the updated firmware image;
beginning activation of the downloaded firmware image upon request;
performing a second compatibility check on the updated firmware image; and
determining compatibility of the updated firmware image with the pre-existing firmware, wherein, in the event of a determined incompatibility between the updated firmware image and pre-existing firmware, the storage device further:
continues a transient code execution phase wherein at least a second incompatibility correcting function of the plurality of incompatibility correcting functions is processed; and
executes the updated firmware image.
